(19) United States
(12) Patent Application Publication
(10) Pub. No.: US 2001/0048991 A1
(43) Pub. Date: Dec. 6, 2001

(54) Compositions for flexible optical media discs

(76) Inventors: Henri-Luc Martin, Midland, MI (US); Mary Ann Jones, Midland, MI (US); Jerry L. Hahnfeld, Midland, MI (US); Gary D. Parsons, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/728,200

(22) Filed: Nov. 30, 2000

Related U.S. Application Data
(63) Continuation-in-part of application No. 09/575,062, filed on May 19, 2000.
(63) Continuation-in-part of application No. 09/575,063, filed on May 19, 2000.
(60) Provisional application No. 60/139,075, filed on Jun. 11, 1999.
(60) Provisional application No. 60/146,008, filed on Jul. 28, 1999.
(60) Provisional application No. 60/193,313, filed on Mar. 30, 2000.
(60) Provisional application No. 60/229,079, filed on Aug. 30, 2000.

(51) Int. Cl. B32B 3/02; C08L 53/00; C25D 1/00; B32B 15/00

(52) U.S. Cl. 428/64.2; 428/64.3; 428/644

(57) ABSTRACT

The present invention is related to flexible information-carrying substrates, such as optical media discs, which can withstand the stresses of being handled, processed and deformed, yet maintain enough integrity and properties such that it can still be read without the use of a rigid adapter.

### CROSS REFERENCE STATEMENT

This application is a Continuation-in-Part of U.S. application Ser. No. 09/575,062, filed May 19, 2000, and U.S. application Ser. No. 09/575,063, filed May 19, 2000; which claim benefit of U.S. Provisional Application No. 60/139,075, filed on Jun. 11, 1999, U.S. Provisional Application No. 60/146,008, filed on Jul. 28, 1999 and U.S. Provisional Application No. 60/193,313, filed on Mar. 30, 2000; and claims benefit of U.S. Provisional Application No. 60/229,079, filed on Aug. 30, 2000.

### BACKGROUND OF THE INVENTION

This invention relates to information-carrying substrates, such as optical media discs and compositions therefore.

Optical media discs and other information-carrying substrates of the current art are typically produced from materials such as polycarbonate. However, with the increasing internet market and capabilities, companies desire to deliver such substrates or readable discs using various methods which require the ability to deform without damaging the disc. In order to achieve this, the substrates or discs must be very flexible in order to survive the handling associated with the automated mail system. Flexible thin film discs have been prepared as described in U.S. Pat. Nos. 4,356,066 and 4,880,514, hereby incorporated by reference, as well as in EP-892,393. However, these discs cannot be read on a standard player without the use of an adapter to give the needed disc rigidity and flatness.

Therefore, there remains a need for a composition which can produce a flexible information-carrying substrate or disc that can withstand stresses such as those inflicted by automated systems associated with the mail system, yet maintain optical properties and structural integrity such that the substrate or disc can be read without the need for a rigid adapter.

### SUMMARY OF THE INVENTION

In one aspect, the present invention is directed to a flexible information-carrying substrate which can be read without the need for a rigid adapter. In another aspect, the present invention is directed to a composition which is especially useful in producing flexible information-carrying substrates, such as optical media discs. Such compositions comprise a polymer having high transparency, an elastic modulus of 25 to 430 MPa, good optical properties, low water absorption, and excellent melt processability.

### DESCRIPTION OF THE PREFERRED EMBODIMENTS

The composition of the present invention comprises a polymer having a sufficient flexibility such that an information-carrying substrate prepared therefrom can withstand the stresses of bending, deforming and handling, yet retain properties such that the substrate can be played and read successfully without the need for a rigid adapter to obtain sufficient rigidity or flatness. Such polymer can be any polymer meeting the needed criteria described above. Information-carrying substrates typically comprise a plastic substrate(s) which holds laser readable data. Information-carrying substrates, include, but are not limited to substrates such as prerecorded or recordable optical media discs; including compact discs, video discs, DVD discs, CD-rewritable discs, optical magnetic discs and optical cards; and traditionally contain information such as computer programs and audio and video recordings.

Flexibility is defined by solid state elastic modulus (G′) as measured at 23° C. and 1 radian/sec, based on Dynamic Mechanical Spectroscopy (DMS) analysis by torsion. Sufficient flexibility is defined as a G′ of between 25 and 430 MPa, preferably between 25 and 350 MPa. Flexibility can also be determined by the absence of crazing or stress whitening after a taco bend test. A taco bend test is performed by bending a standard size optical media disc such that opposing edges touch, thus forming a taco like shape, and releasing and is well known by those skilled in the art.

In one embodiment, the composition comprises a block copolymer having at least three blocks as represented by the formula ABA, wherein A is a block of a first polymer and B is a block of a second polymer and include triblock, multi-block, tapered block, and star block copolymers, e.g. as SB′S, SB′SB′S, and the like (wherein S is polystyrene, B′ is polybutadiene). The block copolymers may, however, contain any number of additional blocks, wherein these blocks may be attached at any point to the block copolymer backbone. Thus, linear blocks would include for example ABA, ABAB, ABABA, ABABAB, and the like. The block copolymer can also be branched, wherein polymer chains are attached at any point along the block copolymer backbone. In addition, blends of any of the aforementioned block copolymers can also be used as well as blends of the block copolymers with their homopolymer counterparts as long as the elastic modulus and other optical properties of the composition are met. In other words, a ABA block copolymer can be blended with a ABABA block copolymer and/or an A homopolymer. It should be noted here that in the production of block copolymers, small amounts of residual diblock copolymers can also be produced.

Block copolymers useful in the flexible compositions of the present invention, advantageously have a specific morphology. Morphology is the mesoscopic self assembly of the blocks in the molten and solid states; producing compositional patterns as described in “Block Copolymers-Designer Soft Materials” Physics Today, February 1999 by Bates and Fredrickson. The specific advantageous morphology for use in flexible information-carrying substrates is a lamellar morphology, wherein the self assembly of blocks is in discrete layers and both phases are co-continuous. Morphology can be determined by SAXS (small angle x-ray scattering) analysis, which is well known by those skilled in the art and described in The Physics of Block Copolymers, Ian W. Hamley, Chapter 5, Oxford University Press, 1998, N.Y.

In one embodiment, the block copolymer is a hydrogenated block copolymer of at least one vinyl aromatic and at least one conjugated diene monomer. The hydrogenated block copolymer comprises at least two distinct blocks of hydrogenated polymerized vinyl aromatic monomer, herein referred to as hydrogenated vinyl aromatic polymer block, and at least one block of hydrogenated polymerized conjugated diene monomer, herein referred to as hydrogenated conjugated diene polymer block. Such hydrogenated block copolymers can be prepared by hydrogenating a block copolymer produced from at least one vinyl aromatic monomer and at least one conjugated diene monomer.

The vinyl aromatic monomer is typically a monomer of the formula:

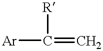

wherein R′ is hydrogen or alkyl, Ar is phenyl, halophenyl, alkylphenyl, alkylhalophenyl, naphthyl, pyridinyl, or anthracenyl, wherein any alkyl group contains 1 to 6 carbon atoms which may be mono or multisubstituted with functional groups such as halo, nitro, amino, hydroxy, cyano, carbonyl and carboxyl. More preferably Ar is phenyl or alkyl phenyl with phenyl being most preferred. Typical vinyl aromatic monomers include styrene, alpha-methylstyrene, all isomers of vinyl toluene, especially paravinyltoluene, all isomers of ethyl styrene, propyl styrene, butyl styrene, vinyl biphenyl, vinyl naphthalene, vinyl anthracene and the like, and mixtures thereof. The block copolymer can contain more than one specific polymerized vinyl aromatic monomer. In other words, the block copolymer can contain a polystyrene block and a poly-alpha-methylstyrene block. The hydrogenated vinyl aromatic polymer block may also be a hydrogenated copolymer of a hydrogenated vinyl aromatic wherein the vinyl aromatic portion is at least 50 weight percent of the copolymer block.

The conjugated diene monomer can be any monomer having two conjugated double bonds. Such monomers include for example 1,3-butadiene, 2-methyl-1,3-butadiene, 2-methyl-1,3 pentadiene, isoprene and similar compounds, and mixtures thereof. In one embodiment, the conjugated diene polymer block is a polybutadiene. Polybutadiene can contain either a 1,2 configuration, which hydrogenates to give the equivalent of a 1-butene repeat unit, or a 1,4-configuration, which hydrogenates to give the equivalent of an ethylene repeat unit. Typically, the weight ratio of 1,2 to 1,4 content of the polybutadiene block is greater than 20:80, generally greater than 25:75, preferably greater than 30:70, and more preferably greater than 35:65. The 1,2 or 1,4 content can be determined by NMR.

A block is herein defined as a polymeric segment of a copolymer which exhibits microphase separation from a structurally or compositionally different polymeric segment of the copolymer. Microphase separation occurs due to the incompatibility of the polymeric segments within the block copolymer. The separation of block segments can be detected by the presence of distinct glass transition temperatures. Microphase separation and block copolymers are widely discussed in “Block Copolymers-Designer Soft Materials”, PHYSICS TODAY, February, 1999, pages 32-38.

Hydrogenated block copolymers useful for the composition of the present invention can be defined as having a weight ratio of hydrogenated conjugated diene polymer block to hydrogenated vinyl aromatic polymer block of 35:65 or more, preferably greater than 45:55. The total weights of the hydrogenated vinyl aromatic polymer blocks and the hydrogenated conjugated diene polymer block(s) is typically at least 80 weight percent, preferably at least 90, and more preferably at least 95 weight percent of the total weight of the hydrogenated copolymer.

The total number average molecular weight (Mₙₜ) of the hydrogenated block copolymers useful in the present invention is typically from 30,000, preferably from 35,000 to 80,000, typically to 75,000, and generally to 70,000. The Mₙ, as referred to throughout the present specification, is determined by gel permeation chromatography. The molecular weight of the hydrogenated block copolymer and properties obtained are dependent upon the molecular weight of each of the hydrogenated polymeric blocks.

The Mₙₐ of the hydrogenated vinyl aromatic polymer block will typically be from 6,000 to 50,000, preferably to 40,000, more preferably to 30,000 and most preferably to 20,000. The hydrogenated conjugated diene polymer block will typically have a M_{nb} of from 3,000, preferably from 8,000 to 40,000, preferably to 35,000, and most preferably to 30,000.

Each individual block of the hydrogenated block copolymer can have its own distinct Mₙ. In other words, for example, two hydrogenated vinyl aromatic polymer blocks within the hydrogenated block copolymer may each have a different Mₙ.

Methods of making block copolymers are well known in the art. Typically, block copolymers are made by anionic polymerization, examples of which are cited in Anionic Polymerization: Principles and Practical Applications, H. L. Hsieh and R. P. Quirk, Marcel Dekker, New York, 1996. In one embodiment, block copolymers are made by sequential monomer addition to a carbanionic initiator such as sec-butyl lithium or n-butyl lithium. In another embodiment, the copolymer is made by coupling a triblock material with a divalent coupling agent such as 1,2-dibromoethane, dichlorodimethylsilane, or phenylbenzoate. In this embodiment, a small chain (less than 10 monomer repeat units) of a conjugated diene polymer can be reacted with the vinyl aromatic polymer coupling end to facilitate the coupling reaction. Vinyl aromatic polymer blocks are typically difficult to couple, therefore, this technique is commonly used to achieve coupling of the vinyl aromatic polymer ends. The small chain of diene polymer does not constitute a distinct block since no microphase separation is achieved. Coupling reagents and strategies which have been demonstrated for a variety of anionic polymerizations are discussed in Hsieh and Quirk, Chapter 12, pgs. 307-331. In another embodiment, a difunctional anionic initiator is used to initiate the polymerization from the center of the block system, wherein subsequent monomer additions add equally to both ends of the growing polymer chain. An example of a such a difunctional initiator is 1,3-bis(1-phenylethenyl)benzene treated with organolithium compounds, as described in U.S. Pat. Nos. 4,200,718 and 4,196,154, which are herein incorporated by reference.

After preparation of the block copolymer, the copolymer is hydrogenated to remove sites of unsaturation in both the conjugated diene polymer block and the vinyl aromatic polymer block segments of the copolymer. Any method of hydrogenation can be used and such methods typically include the use of metal catalysts supported on an inorganic substrate, such as Pd on BaSO4 (U.S. Pat. No. 5,352,744) and Ni on kieselguhr (U.S. Pat. No. 3,333,024) both of which are incorporated herein by reference. Additionally, soluble, homogeneous catalysts such those prepared from combinations of transition metal salts of 2-ethylhexanoic acid and alkyl lithiums can be used to fully saturate block copolymers, as described in Die Makromolekulare Chemie, Volume 160, pp. 291, 1972. The copolymer hydrogenation can also be achieved using hydrogen and a heterogeneous catalyst such as those described in U.S. Pat. No. 5,352,744, U.S. Pat. No. 5,612,422 and U.S. Pat. No. 5,645,253 which are herein incorporated by reference. The catalysts described therein are heterogeneous catalysts consisting of a metal crystallite supported on a porous silica substrate. An example of a silica supported catalyst which is especially useful in the polymer hydrogenation is a silica which has a surface area of at least 10 m²/g which is synthesized such that is contains pores with diameters ranging between 500 and 6000 angstroms. This silica is then impregnated with a metal capable of catalyzing hydrogenation of the polymer, such as nickel, cobalt, rhodium, ruthenium, palladium, platinum, other Group VIII metals, combinations or alloys thereof.

Alternatively, the hydrogenation can be conducted in the presence of a mixed hydrogenation catalyst characterized in that it comprises a mixture of at least two components. The first component comprises any metal which will increase the rate of hydrogenation and includes nickel, cobalt, rhodium, ruthenium, palladium, platinum, other Group VIII metals, or combinations thereof. Preferably rhodium and/or platinum is used. However, platinum is known to be a poor hydrogenation catalyst for nitrites, therefore, platinum would not be preferred in the hydrogenation of nitrile copolymers. The second component used in the mixed hydrogenation catalyst comprises a promoter which inhibits deactivation of the Group VIII metal(s) upon exposure to polar materials, and is herein referred to as the deactivation resistant component. Such components preferably comprise rhenium, molybdenum, tungsten, tantalum or niobium or mixtures thereof.

The amount of the deactivation resistant component in the mixed catalyst is at least an amount which significantly inhibits the deactivation of the Group VIII metal component when exposed to polar impurities within a polymer composition, herein referred to as a deactivation inhibiting amount. Deactivation of the Group VIII metal is evidenced by a significant decrease in hydrogenation reaction rate. This is exemplified in comparisons of a mixed hydrogenation catalyst and a catalyst containing only a Group VIII metal component under identical conditions in the presence of a polar impurity, wherein the catalyst containing only a Group VIII metal component exhibits a hydrogenation reaction rate which is less than 75 percent of the rate achieved with the mixed hydrogenation catalyst.

Preferably, the amount of deactivation resistant component is such that the ratio of the Group VIII metal component to the deactivation resistant component is from 0.5:1 to 10:1, more preferably from 1:1 to 7:1, and most preferably from 1:1 to 5:1.

The mixed catalyst can consist of the components alone, but preferably the catalyst additionally comprises a support on which the components are deposited. In one embodiment, the metals are deposited on a support such as a silica, alumina or carbon. In a more specific embodiment, a silica support having a narrow pore size distribution and surface area greater than 10 meters squared per gram (m²/g) is used.

The pore size distribution, pore volume, and average pore diameter of the support can be obtained via mercury porosimetry following the proceedings of ASTM D-4284-83.

The pore size distribution is typically measured using mercury porosimetry. However, this method is only sufficient for measuring pores of greater than 60 angstroms. Therefore, an additional method must be used to measure pores less than 60 angstroms. One such method is nitrogen desorption according to ASTM D-4641-87 for pore diameters of less than about 600 angstroms. Therefore, narrow pore size distribution is defined as the requirement that at least 98 percent of the pore volume is defined by pores having pore diameters greater than 300 angstroms and that the pore volume measured by nitrogen desorption for pores less than 300 angstroms, be less than 2 percent of the total pore volume measured by mercury porosimetry.

The surface area can be measured according to ASTM D-3663-84. The surface area is typically between 10 and 100 m²/g, preferably between 15 and 90 with most preferably between 50 and 85 m²/g.

The desired average pore diameter of the support for the mixed catalyst is dependent upon the polymer which is to be hydrogenated and its molecular weight (Mₙ). It is preferable to use supports having higher average pore diameters for the hydrogenation of polymers having higher molecular weights to obtain the desired amount of hydrogenation. For high molecular weight polymers (Mₙ≧200,000 for example), the typical desired surface area can vary from 15 to 25 m²/g and the desired average pore diameter from 3,000 to 4,000 angstroms. For lower molecular weight polymers (Mₙ<200,000 for example), the typical desired surface area can vary from 45 to 85 m²/g and the desired average pore diameter from 300 to 700 angstroms.

Silica supports are preferred and can be made by combining potassium silicate in water with a gelation agent, such as formamide, polymerizing and leaching as exemplified in U.S. Pat. No. 4,112,032. The silica is then hydrothermally calcined as in Iler, R. K., The Chemistry of Silica, John Wiley and Sons, 1979, pp. 539-544, which generally consists of heating the silica while passing a gas saturated with water over the silica for about 2 hours or more at temperatures from about 600° C. to about 850° C. Hydrothermal calcining results in a narrowing of the pore diameter distribution as well as increasing the average pore diameter. Alternatively, the support can be prepared by processes disclosed in Iler, R. K., The Chemistry of Silica, John Wiley and Sons, 1979, pp. 510-581.

A silica supported catalyst can be made using the process described in U.S. Pat. No. 5,110,779, which is incorporated herein by reference. An appropriate metal, metal component, metal containing compound or mixtures thereof, can be deposited on the support by vapor phase deposition, aqueous or nonaqueous impregnation followed by calcination, sublimation or any other conventional method, such as those exemplified in Studies in Surface Science and Catalysis, “Successful Design of Catalysts” V. 44, pg. 146-158, 1989 and Applied Heterogeneous Catalysis pgs. 75-123, Institute Français du Pétrole Publications, 1987. In methods of impregnation, the appropriate metal containing compound can be any compound containing a metal, as previously described, which will produce a usable hydrogenation catalyst which is resistant to deactivation. These compounds can be salts, coordination complexes, organometallic compounds or covalent complexes.

Typically, the total metal content of the mixed supported catalyst is from 0.1 to 10 wt. percent based on the total weight of the silica supported catalyst. Preferable amounts are from 2 to 8 wt. percent, more preferably 0.5 to 5 wt. percent based on total catalyst weight.

Promoters, such as alkali, alkali earth or lanthanide containing compounds, can also be used to aid in the dispersion of the metal component onto the silica support or stabilization during the reaction, though their use is not preferred.

The amount of mixed supported catalyst used in the hydrogenation process is much smaller than the amount required in conventional unsaturated polymer hydrogenation reactions due to the high reactivity of the hydrogenation catalysts. Generally, amounts of less than 1 gram of supported catalyst per gram of unsaturated polymer are used, with less than 0.1 gram being preferred and less than 0.05 being more preferred. The amount of supported catalyst used is dependent upon the type of process, whether it is continuous, semi-continuous or batch, and the process conditions, such as temperature, pressure and reaction time wherein typical reaction times may vary from about 5 minutes to about 5 hours. Continuous operations can typically contain 1 part by weight supported catalyst to 200,000 or more parts unsaturated polymer, since the supported catalyst is reused many times during the course of continuous operation. Typical batch processes can use 1 part by weight supported catalyst to 5,000 parts unsaturated polymer. Higher temperatures and pressures will also enable using smaller amounts of supported catalyst.

The hydrogenation reaction can be conducted in the absence of a solvent but is preferably conducted in a hydrocarbon solvent in which the polymer is soluble and which will not hinder the hydrogenation reaction. Preferably the solvent is a saturated solvent such as cyclohexane, methylcyclohexane, ethylcyclohexane, cyclooctane, cycloheptane, dodecane, dioxane, diethylene glycol dimethyl ether, tetrahydrofuran, isopentane, decahydronaphthalene or mixtures thereof, with cyclohexane being the most preferred.

The temperature at which the hydrogenation is conducted can be any temperature at which hydrogenation occurs without significant degradation of the polymer. Degradation of the polymer can be detected by a decrease in Mₙ, an increase in polydispersity or a decrease in glass transition temperature, after hydrogenation. Significant degradation in polymers having a polydispersity between 1.0 and about 1.2 can be defined as an increase of 30 percent or more in polydispersity after hydrogenation. Preferably, polymer degradation is such that less than a 20 percent increase in polydispersity occurs after hydrogenation, most preferably less than 10 percent. In polymers having polydispersity greater than about 1.2, a significant decrease in molecular weight after hydrogenation indicates that degradation has occurred. Significant degradation in this case is defined as a decrease in Mₙ of 20 percent or more. Preferably, a Mₙ decrease after hydrogenation will be less than 10 percent. However, polymers such as poly-alpha-methylstyrene or other alpha substituted vinyl aromatic polymers which are more prone to polymer degradation, can tolerate a decrease in Mₙ of up to 30 percent.

Typical hydrogenation temperatures are from about 40° C. preferably from about 100° C., more preferably from about 110° C., and most preferably from about 120° C. to about 250° C., preferably to about 200° C., more preferably to about 180° C., and most preferably to about 170° C.

The pressure of the hydrogenation reaction is not critical, though hydrogenation rates increase with increasing pressure. Typical pressures range from atmospheric pressure to 70 MPa, with 0.7 to 10.3 MPa being preferred.

The hydrogenation reaction vessel is purged with an inert gas to remove oxygen from the reaction area. Inert gases include but are not limited to nitrogen, helium, and argon, with nitrogen being preferred.

The hydrogenating agent can be any hydrogen producing compound which will efficiently hydrogenate the unsaturated polymer. Hydrogenating agents include, but are not limited, to hydrogen gas, hydrazine and sodium borohydride. In a preferred embodiment, the hydrogenating agent is hydrogen gas.

The level of hydrogenation of the block copolymer is generally greater than 95 percent of the conjugated diene polymer block and greater than 90 percent of the vinyl aromatic polymer block segments, typically greater than 99 percent of the conjugated diene polymer block and greater than 95 percent of the vinyl aromatic polymer block segments, preferably greater than 99.5 percent of the conjugated diene polymer block and greater than 97 percent of the vinyl aromatic polymer block segments, more preferably greater than 99.9 percent of the conjugated diene polymer block and 98.5 percent of the vinyl aromatic polymer block segments, even more preferably greater than 99 percent of the vinyl aromatic polymer segments. The term ‘level of hydrogenation’ refers to the percentage of the original unsaturated bonds which become saturated upon hydrogenation. The level of hydrogenation for the hydrogenated vinyl aromatic polymer block is determined by UV-VIS spectrophotometry, while the level of hydrogenation of the hydrogenated conjugated diene polymer block is determined by proton NMR.

The composition of the present invention is useful in the production of flexible optical media storage devices such as discs, and other media or information-carrying substrates. It is recognized that the use of this composition is not limited to current optical media formats, but can also be used in future formats which require the advantageous properties of the composition.

In particular, composition of the present invention is useful in the production of flexible optical storage media devices and components thereof. Optical storage media components can include a transparent substrate, a protective layer, a protective case, and/or an information layer, any of which can comprise the composition of the present invention. Examples of storage media formats which use these devices include, but are not limited to prerecorded, recordable and rewriteable versions of CD and DVD formats, optical recording mediums such as those disclosed in U.S. Pat. No. 4,965,114 and U.S. Pat. No. 5,234,792, incorporated herein by reference, all of which are well known in the art and discussed in The Compact Disc Handbook 2^{nd} Edition by Pohlmann.

The composition of the present invention can be used to produce the information-carrying transparent substrates for both CD (compact disc) and DVD (digital versatile disc) prerecorded formats as, for example, disclosed in U.S. Pat. No. 5,635,114, incorporated herein by reference. In the case of the CD format the transparent substrate is coated with a reflective metal layer, e.g. aluminum, followed by a protective coating, e.g. a U.V. curable lacquer. The DVD structure includes two information-carrying substrates, e.g. comprising the composition of the present invention, which are sputtered with an aluminum reflective layers, or gold or silicon semi-reflective layers. The individual substrates are bonded together to form a dual layer disc with an overall thickness equal to the thickness of a CD media device.

The composition of the present invention is also useful for the production of substrates with a wobbled spiral groove for recordable optical disc formats. The substrate is typically coated with a light absorbing dye layer and then a reflective layer. Examples of reflective layers include gold or silver. During the recording process the dye absorbs heat from the laser beam recorder. The substrate, dye and reflective layer composite structure is deformed by the heat which forms a permanent pit. Signal strength is enhanced by optical change in the dye. Dual layer DVD style media differs from CD format in that two groove containing substrates are bonded together to form a single optical storage device with information stored on two layers.

In a specific embodiment, one aspect of the present invention is a flexible pre-recorded or recordable optical media disc comprising:

(a′) a first substrate layer;

(b′) an optional first photosensitive dye layer;

(c′) at least one group of the following two reflective or semi-reflective sublayers:

(i′) a first sublayer comprising a metal, an inorganic carbide, or an inorganic nitride;

(ii′) a second sublayer comprising a protective or adhesive composition;

(d′) an optional second metal/inorganic layer comprising a metal, an inorganic carbide, or an inorganic nitride;

(e′) an optional second photosensitive dye layer;

(f′) an optional second substrate layer;

wherein at least one of the first substrate layer or optional second substrate layer comprises the composition of the present invention.

Suitable photosensitive dye layers include photosensitive nitrogen-containing compounds, such as cyanine, phthalocyanine, and azo-compounds. Typically, the photosensitive dye layer will be at least 1 microns, preferably at least 10 microns; typically no more than 100 microns, preferably no more than 75 microns.

Suitable reflective or semi-reflective metal layers and sublayers include elemental aluminum, silver, or gold. Other suitable reflective or semi-reflective sublayers include silicon compounds such as silicon nitride and silicon carbide. Typically, the reflective or semi-reflective layer or sublayer will be at least 5 nm, preferably at least 10 nm; typically no more than 100 nm, preferably no more than 30 nm in thickness. The metal layer may be applied by cathode sputtering techniques well-known in the art.

Suitable protective compositions include, for example, photocured acrylates (such as polymethylmethacrylate, epoxy acrylates). Such lacquers will include a photoinitiator, such as to result in, e.g., radical curing or cationic UV curing of the lacquer.

Suitable adhesive compositions include hot melt or solvent based adhesives. Such adhesives will typically comprise a polymeric component (e.g., polyethylene, styrene block copolymers (including block copolymers having been hydrogenated along the backbone, such as SBS, SEBS, SPS, SEPS, and SIS), amorphous polyolefins, etc.), in conjunction with one or more additional components selected from the group consisting of waxes, tackifiers, plasticizers, and fillers. The polymeric component may be optionally functionalized, such as to promote adhesion between the adjacent components.

In a specific embodiment, the composition of the present invention are used to produce pre-recorded audio compact discs (CD-audio). Specifications for a compact disc system are well known in the art and disclosed in The Compact Disc Handbook, 2^{nd} Edition, Pohlmann, pg. 49. The disc diameter is 120 millimeters (mm), the hole diameter is 15 mm and the thickness is 1.2 mm. Data is recorded on an area 35.5 mm wide. The CD substrate comprises the hydrogenated block copolymers of the present invention and is transparent. Data is physically contained in pits which are impressed along its top surface and are covered with a very thin (50 to 100 nanometers) metal such as aluminum, silver or gold. Another thin plastic layer of 10 to 30 micrometers protects the metallized pit surface, on top of which the identifying label is printed.

A specific embodiment of the present invention is a flexible pre-recorded CD comprising:

(a1) a substrate layer;

(b1) a metal layer, wherein the metal is preferably selected from the group consisting of aluminum, silver, or gold; and

(c1) a lacquer layer;

wherein the substrate comprises the composition of the present invention.

In another specific embodiment, the optical media disc will be a flexible CD-R (recordable), comprising:

(a2) a substrate;

(b2) a photosensitive dye layer;

(c2) a reflective or semi-reflective metal layer; and

(d2) a lacquer.

The substrate, dye layer, metal and lacquer are as described previously.

In another specific embodiment, the optical media disc can be a flexible DVD such as a DVD-5 disk, comprising:

(a3) a first substrate layer;

(b3) a metal layer, preferably selected from the group consisting of gold and silver;

(c3) a lacquer layer; and

(d3) a second substrate layer,

wherein at least one of the first substrate layer or second substrate layer comprises the composition of the present invention.

In another embodiment, the optical media disc will be a flexible DVD-9 disc, (in the term DVD-#, the # designates the approximate total Gigabytes of information) comprising:

(a4) a first substrate layer;

(b4) an inorganic carbide or inorganic nitride layer, preferably selected from the group consisting of silica carbide and silica nitride, or alternatively a gold layer;

(c4) a lacquer layer;

(d4) a metal layer, typically aluminum or alloy thereof; and

(e4) a second substrate layer,

wherein at least one of the first substrate layer or second substrate layer comprises the composition of the present invention.

In another embodiment, the optical media disc will be a flexible DVD-14 disc, comprising:

(a5) a first substrate layer;

(b5) an inorganic carbide or inorganic nitride layer, preferably selected from the group consisting of silica carbide and silica nitride, or alternatively a gold layer;

(c5) a lacquer layer;

(d5) at least one group of the following two sublayers:

(i5) a first sublayer comprising a metal, an inorganic carbide, or an inorganic nitride, preferably a metal in each instance, more preferably aluminum or gold in each instance;

(ii5) a second sublayer comprising a protective lacquer or an adhesive composition;

(e5) a second substrate layer;

wherein at least one of the first substrate layer and the second substrate layer comprises the composition of the present invention.

In another embodiment, the optical media disc will be a flexible DVD-18 disc, comprising:

(a6) a first substrate layer;

(b6) a first inorganic carbide or inorganic nitride layer, preferably selected from the group consisting of silica carbide and silica nitride, or alternatively a gold layer;

(c6) a lacquer layer;

(d6) at least two groups of the following two sublayers:

(i6) a first sublayer comprising a metal, an inorganic carbide, or an inorganic nitride, preferably a metal in each instance, more preferably aluminum or gold in each instance;

(ii6) a second sublayer comprising a protective lacquer or an adhesive composition;

(e6) a second inorganic carbide or inorganic nitride layer, preferably selected from the group consisting of silica carbide and silica nitride; and

(f6) a second substrate layer;

wherein at least one of the first substrate layer and the second substrate layer comprises the composition of the present invention.

Metal layers, lacquers and inorganics recited herein, are as previously described herein.

The composition of the present invention can also be used in other flexible CD formats including CD-ROM, CD-I, DVI, CD-V, CD+G/M, mini-discs and CD-3. CD-ROM (Read Only Memory) incorporates nonaudio data, such as data base and software data. CD-I (Interactive) and DVI are specific applications of CD-ROM, wherein data storage includes audio-visual information stored in a user—interactive manner. DVI (Digital Video Interactive) is an all digital optical disc format capable of reproducing full-motion, full-screen video, computer-generated video graphics and digital audio via a CD-ROM drive. CD-V is a combination of audio and video technology which merges the audio with Laservision video format. Other CD formats which can be produced from the composition of the present invention include CD+G/M (Graphics) which is a storage disc for graphics and other nonmusical data. This format takes advantage of the nonaudio data area, wherein still color images, text or other material is stored on an audio compact disc and displayed on a television monitor while the music plays. Another format is CD-3 which is used for applications requiring shorter playing time. The data format is identical to the regular 12 cm diameter CD, but its diameter is only 8 cm and can additionally be used for CD-ROM applications. Photo CD's and CDTV may also be produced from the composition of the present invention. CDTV, which is similar to CD-I, employs the compact disc standard as a basis for multimedia presentations of audio and video including images, graphics, text and animation.

The composition of the present invention can also be used as the transparent substrate and/or the protective layer of a flexible rewritable/erasable disc having one or more layers. In this case the recording layer is sandwiched between a transparent substrate, e.g. comprising the composition of the present invention, and a protective layer. The recording layer is typically approximately 50 nm thick. Recording layers include magneto-optical and phase-change layers. For magneto-optical formats several magnetic materials can be used for recording layers including rare-earth transition metals such as gadolinium terbium iron, terbium iron cobalt, and terbium iron.

In one embodiment, the flexible rewritable/erasable disc comprises:

(a7) a substrate;

(b7) a recordable metal layer; and

(c7) a protective layer,

wherein the substrate comprises the composition of the present invention.

In particular, the composition of the present invention will be usefully employed in a flexible rewriteable/erasable optical media disc comprising:

(a8) a first substrate layer

(b8) a first inorganic layer;

(c8) a metal alloy layer;

(d8) a second inorganic layer;

(e8) a metal layer;

(f8) a lacquer layer; and

(g8) optionally, one or more of an optional second metal layer, an optional third and/or fourth inorganic layer, and optional second metal alloy layer, and an optional second substrate layer,

wherein at least one of the first substrate layer and the optional second substrate layer comprises the composition of the present invention.

In another specific embodiment, flexible rewriteable/erasable CD's can also be produced from the composition of the present invention. In one embodiment, a flexible rewriteable/erasable CD comprises:

(a8′) a substrate;

(b8′) a barrier layer;

(c8′) a magneto optical layer or a phase change layer;

(d8′) a barrier layer;

(e8′) a reflective or semi-reflective metal layer;

(f8′) a lacquer.

The substrate comprises the composition of the present invention. The barrier layer is typically a tin nitride for magneto optical or ZnS—SiO₂ for phase change discs. The magneto optical layer is, for example TbFeCo, while the phase change layer is, for example an alloy of TeGeSb. The reflective or semi-reflective layers are as taught previously and are preferably an aluminum alloy. The lacquer typically comprises a photocurable acrylic as taught previously.

Rewritable and erasable DVD formats include DVD-RAM (Random Access Memory), DVD+RW(Rewriteable) and DVD−R/W(Rewriteable) formats which are all based on phase change technology. Phase change technology uses the difference in reflectivity of the low reflectivity amorphous or high reflectivity crystalline state. The phase change alloy is made of tellurium, germanium and antimony (TeGeSb). The active phase change layer is surrounded by two dielectric films (ZnS—SiO₂) and covered by an aluminum alloy reflector and protective coating. The difference in reflectivity of the phase change layer is accomplished by heating the layer by laser beam and this becomes the data storage surface.

Additionally, the composition of the present invention can be used to produce a flexible mini-disc. The mini-disc is a 2.5 inch, recordable, erasable, optical disc format, which stores 74 minutes of stereo digital audio. Mini-discs and methods of making are well known to those skilled in the art.

In another embodiment, the composition of the present invention are used to produce flexible thin film discs. Thin film discs are disclosed in U.S. Pat. Nos. 4,356,066 and 4,880,514, incorporated herein by reference, as well as in EP-892,393. U.S. Pat. No. 4,356,066 discloses multi-layer magnetic thin film discs comprising a synthetic resin layer on an aluminum-containing substrate and an overlying metallic magnetic layer. In one embodiment of the present invention a flexible thin film disc is produced comprising,

(a10) a substrate;

(b10) a synthetic resin layer;

(c10) at least one thin metal layer which may also serve as a metallic magnetic layer; and

(d10) optionally, a metallic magnetic layer, if not included in c9).

wherein the substrate or synthetic resin layer comprises the composition of the present invention.

Methods of making optical media storage devices are well known in the art and described in The Compact Disc Handbook 2^{nd} Edition by Pohlmann, and referenced in U.S. Pat. No. 4,911,966, as well as in U.S. Pat. No. 5,635,114; U.S. Pat. No. 5,468,324; and U.S. Pat. No. 5,663,016, all of which are herein incorporated by reference.

Methods of making information-carrying substrates such as optical media discs are well known in the art and described in The Compact Disc Handbook 2^{nd} Edition by Pohlmann, and referenced in U.S. Pat. No. 4,911,966, as well as in U.S. Pat. No. 5,635,114; U.S. Pat. No. 5,468,324; and U.S. Pat. No. 5,663,016, all of which are herein incorporated by reference.

In one embodiment, the flexible information-carrying substrate of the present invention has a retardation of less than 100 nm per 1.2 mm substrate, and a water absorbance of less than 0.05% as measured according to ASTM D 570. Retardation is measured by placing a molded DVD disc substrate between crossed polarizers and quarter wave plates (oriented in opposition). The retardation is measured 20 mm from the injection gate of the disc using light from a 633 nm laser. Transmitted intensity is measured and the retardation calculated using the following formula:

I=I0 sin2((π/λ)(Δnd))

where

Retardation=Δnd

Measured intensity=I

Incident intensity=I0

Wavelength=λ

Birefringence is calculated from the measured retardation by dividing retardation by the thickness of the substrate. Preferably the retardation is less than 100 nm, more preferably less than 75 nm and most preferably less than 50 nm in a disc substrate which is 1.2 mm thick. The water absorbance is preferably less than 0.04%, more preferably less than 0.02% and most preferably less than 0.01%.

In one embodiment, the composition comprises a hydrogenated block copolymer of at least two hydrogenated vinyl aromatic polymer blocks and at least one hydrogenated butadiene polymer blocks, wherein the hydrogenated copolymer is characterized by:

a) a weight ratio of hydrogenated butadiene polymer block to hydrogenated vinyl aromatic polymer block of 35:65 or more;

b) a total number average molecular weight (Mₙₜ) of from 30,000 to 80,000, wherein each hydrogenated vinyl aromatic polymer block (A) has a Mₙₐ of from 6,000 to 50,000 and each hydrogenated butadiene polymer block (B) has a M_{nb} of from 3,000 to 40,000;

c) a hydrogenation level such that each hydrogenated vinyl aromatic polymer block has a hydrogenation level of greater than 90 percent and each hydrogenated butadiene polymer block has a hydrogenation level of greater than 95 percent; and

d) a weight ratio of 1,2 to 1,4 polybutadiene content of greater than 20:80.

The following examples are provided to illustrate the present invention. The examples are not intended to limit the scope of the present invention and they should not be so interpreted. Amounts are in weight parts or weight percentages unless otherwise indicated.

### EXAMPLES

### Preparation of Pt/Re Catalyst

A solution of 0.411 grams (g) H₂PtCl₆.6(H₂O) and 0.147 g of NH₄ReO₄ is dissolved in 15.55 grams of purified water. This solution is then added to 5.0 g of silica which is then air dried overnight, and further dried at 110° C. in an air purged oven for 30 minutes. The catalyst is reduced in flowing hydrogen at 150° C. for 1 hour to yield a catalyst having 3 weight percent Pt and 2 weight percent Re on SiO₂.

### Hydrogenation of Block Copolymer Using a Pt/Re Catalyst

1.0 g of the reduced Pt/Re catalyst prepared as described above is added to 240 g of a 15 weight % solution of a block copolymer, as described in Resin Example 1 and 2, in cyclohexane, in a stirred autoclave style reactor. The reactor is sealed, the vapor space is purged with nitrogen and filled with pure hydrogen. The temperature is then raised to about 165° C. and the reactor is pressurized with pure hydrogen to 10.3 MPa. The polymer undergoes rapid hydrogenation and analysis shows 100% saturation of the olefin region and greater than 99.96% hydrogenation of the aromatic region. Hydrogenation consumption under reaction conditions occurs over about a 90 minute time period.

### CD Procedure

A CD substrate is injection molded from the hydrogenated block copolymer of Resin Example 1 and 2, using an injection molding machine with a maximum clamping force 600 kN, maximum injection stroke capability of 100 mm and injection screw diameter of 32 mm. The substrate mold is a CD single cavity substrate mold. A data bearing stamper is inserted into the mold which contains approximately 0.6 Gb of data and a track pitch of approximately 1.6 microns. Process temperatures are melt temperatures of 280 to 330° C., and mold temperatures of 30 to 80° C. Injection velocity is varied from 25 mm/s to 125 mm/s, increasing as the mold is filled. Once filled, the part is further packed with polymer by applying initial hold pressure of approximately 600 bar, which is then reduced to 0 bar over a period of 0.3 sec. The polymer injection shot size is approximately 30 mm to achieve a completely full part with an actual part thickness of 1.2 mm. The CD substrate is 120 mm in diameter and 1.2 mm thick.

The CD substrate is inert gas plasma sputtered to deposit a reflective aluminum layer followed by a UV curable lacquer protective layer.

### Example Resin 1

### Molecular Properties of Hydrogenated Styrene-Butadiene-Styrene (SBS) Triblock Copolymer

Actual Mp=39600 (Mp=peak molecular weight before hydrogenation/GPC analysis)

Actual % PS before hydrogenation (via NMR)=51%

Actual % BD before hydrogenation (via NMR)=49%

Actual % 1,2 Content (via NMR)=40%

% Hydrogenation=100%

Solid State Elastic Modulus

G′ at 23° C., 1 rad/sec=101 MPa

Melt Rheology

Complex Viscosity (280° C., 1 rad/sec)=<1000 poise

Elastic Modulus (240° C., 1 rad/sec)=<1000 dynes/sq cm

A flexible disc with excellent pit replication is produced and can be played or read without the need for a rigid adapter.

The disc has no stress whitening after performing a taco bend test.

### Example Resin 2

### SBS Triblock Copolymer

### Molecular Properties

Actual Mp=46000 (peak molecular weight before hydrogenation/GPC analysis)

Actual % PS before hydrogenation (via NMR)=61%

Actual % BD before hydrogenation (via NMR)=39%

Actual % 1,2 Content (via NMR)=42%

% Hydrogenation=100

Solid State Modulus

G′ at 23° C., 1 rad/sec=312 MPa

Melt Rheology

Complex Viscosity (280C, 1 rad/sec)=<1000 poise

Elastic Modulus (240C, 1 rad/sec)=<1000 dynes/sq cm

A flexible disc with excellent pit replication is produced and can be played or read without the need for a rigid adapter.

The disc has no stress whitening after performing a taco bend test.

What is claimed is:

1. A flexible optical media information-carrying substrate produced from a polymer composition having an solid state elastic modulus(G′) of from 25 to 430 MPa at 23° C. at 1 radian/sec based on DMS analysis in torsion.

2. The information-carrying substrate of claim 1, wherein the polymer composition comprises a block copolymer.

3. The information-carrying substrate of claim 2, wherein the block copolymer has a lamellar morphology.

4. The information-carrying substrate of claim 3, wherein the block copolymer comprises at least two hydrogenated vinyl aromatic polymer blocks and at least one hydrogenated conjugated diene polymer block.

5. The information-carrying substrate of claim 4 wherein the hydrogenated conjugated diene is hydrogenated butadiene, hydrogenated isoprene or a mixture thereof.

6. The information-carrying substrate of claim 5, wherein the hydrogenated conjugated diene is hydrogenated butadiene having a 1,2 content of greater than 25 percent.

7. The information-carrying substrate of claim 2 wherein the block copolymer is an alternating triblock copolymer comprising two hydrogenated vinyl aromatic polymer blocks and one hydrogenated butadiene polymer block.

8. The information-carrying substrate of claim 2 wherein the block copolymer is an alternating triblock copolymer comprising two hydrogenated vinyl aromatic polymer blocks and one hydrogenated isoprene polymer block.

9. The information-carrying substrate of claim 6, wherein the hydrogenated vinyl aromatic polymer block is hydrogenated polystyrene.

10. The information-carrying substrate of claim 1 having a retardation of less than 100 nm per 1.2 mm substrate.

11. The information-carrying substrate of claim 2 wherein the ratio of the hydrogenated vinyl aromatic polymer block to the hydrogenated conjugated diene polymer block is from 35:65 to 65:35.

12. A composition comprising a polymer having an elastic modulus (G′) of from 25 to 430 MPa at 23° C. at 1 radian/sec based on DMS analysis in torsion, and a water absorbance of less than 0.05 percent as measured by ASTM D570, comprising a hydrogenated alternating block copolymer, wherein the hydrogenated block copolymer comprises at least two distinct blocks of hydrogenated polymerized vinyl aromatic monomer, herein referred to as hydrogenated vinyl aromatic polymer block, and at least one block of hydrogenated polymerized butadiene monomer, herein referred to as hydrogenated butadiene polymer block, wherein the hydrogenated block copolymer is further characterized by:
a) a weight ratio of hydrogenated butadiene polymer block to hydrogenated vinyl aromatic polymer block of 35:65 or more;
b) a total number average molecular weight (Mₙₜ) of from 30,000 to 80,000, wherein each hydrogenated vinyl aromatic polymer block (A) has a Mₙₐ of from 6,000 to 50,000 and each hydrogenated butadiene polymer block (B) has a M_{nb} of from 3,000 to 40,000;
c) a hydrogenation level such that each hydrogenated vinyl aromatic polymer block has a hydrogenation level of greater than 90 percent and each hydrogenated butadiene polymer block has a hydrogenation level of greater than 95 percent;
d) a weight ratio of 1,2 to 1,4 polybutadiene content of greater than 20:80; and
e) a lamellar morphology.

13. The composition of claim 12, wherein the vinyl aromatic monomer is styrene.

14. A flexible optical media disc produced from the composition of claim 12.

15. The flexible optical media disc of claim 14, wherein the disc is a thin film disc comprising,
(a10) a substrate;
(b10) a synthetic resin layer;
(c10) at least one thin metal layer which may also serve as a metallic magnetic layer; and
(d10) optionally, a metallic magnetic layer, if not included in c9);
wherein the substrate or synthetic resin layer comprises the composition of claim 12.

16. The flexible optical media disc of claim 15, wherein the disc is a thin film disc comprising
(a11) a substrate;
(b11) a metal layer; and
(c11) a metal alloy recording layer;
wherein the substrate comprises the composition of claim 12.
